(19) United States
(12) Patent Application Publication
(10) Pub. No.: US 2009/0128291 A1
(43) Pub. Date: May 21, 2009

(54) METHOD AND APPARATUS OF RFID COMMUNICATION DURING DEVICE ASSEMBLY

(75) Inventors: Ahmadreza (Reza) Rofougaran, Newport Coast, CA (US); Maryam Rofougaran, Rancho Palos Verdes, CA (US)

Correspondence Address: GARLICK HARRISON & MARKISON, P.O. BOX 160727, AUSTIN, TX, 78716-0727, US

(73) Assignee: BROADCOM CORPORATION, Irvine, CA (US)

(21) Appl. No.: 11/942,347

(22) Filed: Nov. 19, 2007

(51) Int. Cl. H04B 7/00

(52) U.S. Cl. 340/10.1; 700/95

(57) ABSTRACT

A method of RFID communication during device assembly includes, at a first production step of a device, determining first assembly information regarding production of the device via a first radio frequency identification (RFID) communication. The method further includes, at a second production step, determining second assembly information regarding the production of the device via a second RFID communication.

### CROSS REFERENCE TO RELATED PATENTS

NOT APPLICABLE

### STATEMENT REGARDING FEDERALLY SPONSORED RESEARCH OR DEVELOPMENT

NOT APPLICABLE INCORPORATION-BY-REFERENCE OF MATERIAL SUBMITTED ON A COMPACT DISC

NOT APPLICABLE

### BACKGROUND OF THE INVENTION

1. Technical Field of the Invention

This invention relates generally to wireless communication systems and more particularly to RFID communications during assembly of a device.

2. Description of Related Art

Device manufacturers use a multitude of manufacturing techniques to track, test, and insure accuracy of manufacturing a device. A few of the manufacturing techniques include automated assembly line processes, sophisticated inventory processes, and bar code markings and scanners. The bar code markings are place on each electrical component, integrated circuit (IC), printed circuit board (PCB), mechanical component, etc. that comprises the device. The bar code scanners are used to record the identity of the parts (e.g., the ICs, PCBs, etc.) being used to produce the device.

While bar coding and bar code scanners work well for tracking the parts that comprise a device during its assembly, bar code scanners require a close proximal positioning to the bar code it is to read. As such, the manufacturing process typically requires bar code scanners to be positioned at particular positions with respect to the assembly of the device and/or may require the device in assembly to be repositioned such that a bar code can be scanned. In either instance, adjustments are made in the manufacture of the device to accommodate the bar code scanners.

In addition, the information contained in a bar code is fixed, and, depending on the symbology of the bar code, the amount of data is limited. For instance, linear symbology bar codes can store a part number, a price, and may further include identity of the manufacturer. Two dimensional symbology bar codes, such as matrix codes, can store more data than a traditional linear symbology bar code. Regardless of the symbology of the bar code, the data contained therein is fixed.

Therefore, a need exists for a method and apparatus for radio frequency identification (RFID) communication during assembly of a device.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE SEVERAL VIEWS OF THE DRAWING(S)

FIG. 1 is a diagram of an embodiment of a device including RFID tags in accordance with the present invention;

FIG. 2 is a diagram of another embodiment of a device including RFID tags in accordance with the present invention;

FIG. 3 is a diagram of an example of a component's information in accordance with the present invention;

FIG. 4 is a diagram of an example of an integrated circuit's information in accordance with the present invention;

FIG. 5 is a diagram of an example of an RFID communication in accordance with the present invention;

FIG. 6 is a logic diagram of an example of an RFID communication in accordance with the present invention; and

FIG. 7 is a logic diagram of an example of an RFID reader processing an RFID communication in accordance with the present invention.

### DETAILED DESCRIPTION OF THE INVENTION

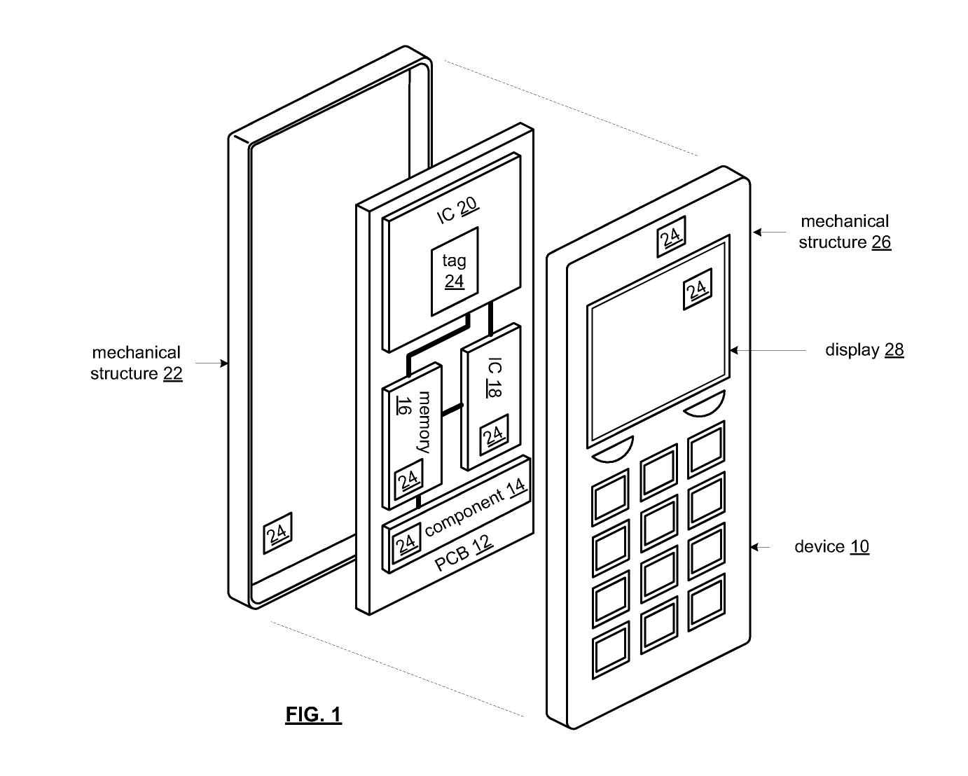

FIG. 1 is a diagram of an embodiment of a device 10 that includes a printed circuit board (PCB) 12, a first mechanical structure 22, a second mechanical structure 26, and a display 28. The PCB 12 includes one or more components 14, one or more memory devices 16, and one or more integrated circuits (ICs) 18-20. The device 10 may be a cellular telephone, a radio, a personal entertainment unit, a handheld video game unit, etc., and may include more components (e.g., resistors, capacitors, inductors, transformers, transistors, light emitting diodes, diodes, connectors, memory, CD ROM reader/burner, etc.), more ICs (e.g., processors, read only memory, random access memory, application specific ICs, digital signal processors, etc.), more PCBs, and/or more mechanical structures (e.g., chassis, brackets, heat sinks, hardware, etc.) than shown in FIG. 1.

In this embodiment each of the parts (e.g., 12-28) of the device 10 includes an associated radio frequency identification (RFID) tag 24. The RFID tags 24 may be active or passive tags integrated into their associated part (e.g., the ICs 18-20 are fabricated to include an RFID tag within the IC) or affixed to their associated part (e.g., an integrated circuit version of an RFID tag is mounted on the PCB 12 or an IC version of the tag is glued to the mechanical structure). In an alternate embodiment, an RFID tag 24 may be affiliated with multiple parts or programmed to be affiliated parts. For example, the RFID tag 24 on the PCB 12 may be used to store item information for the PCB itself and for one or more parts mounted on the PCB (e.g., component 14).

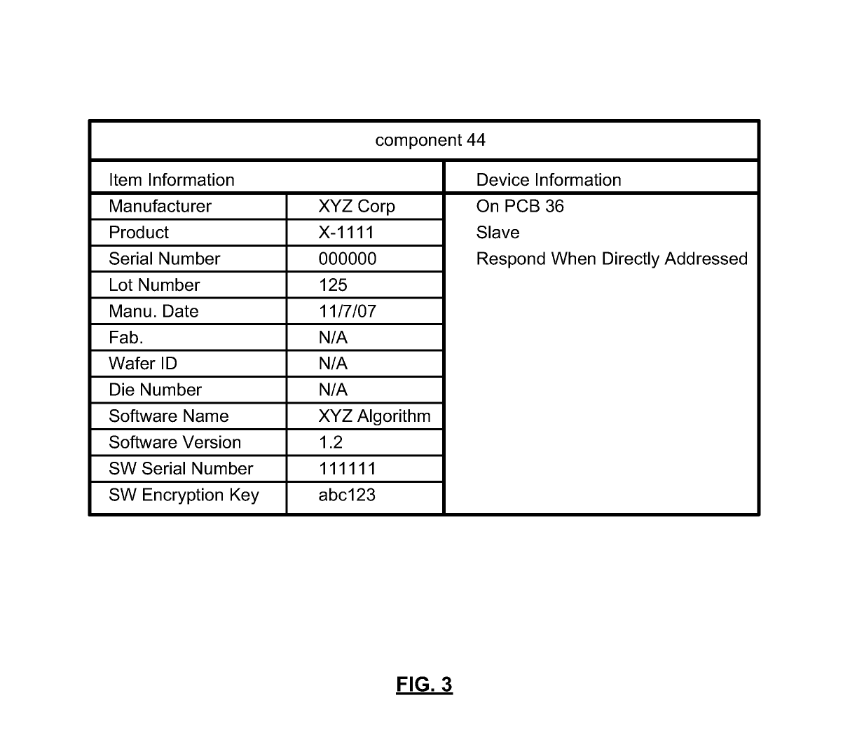

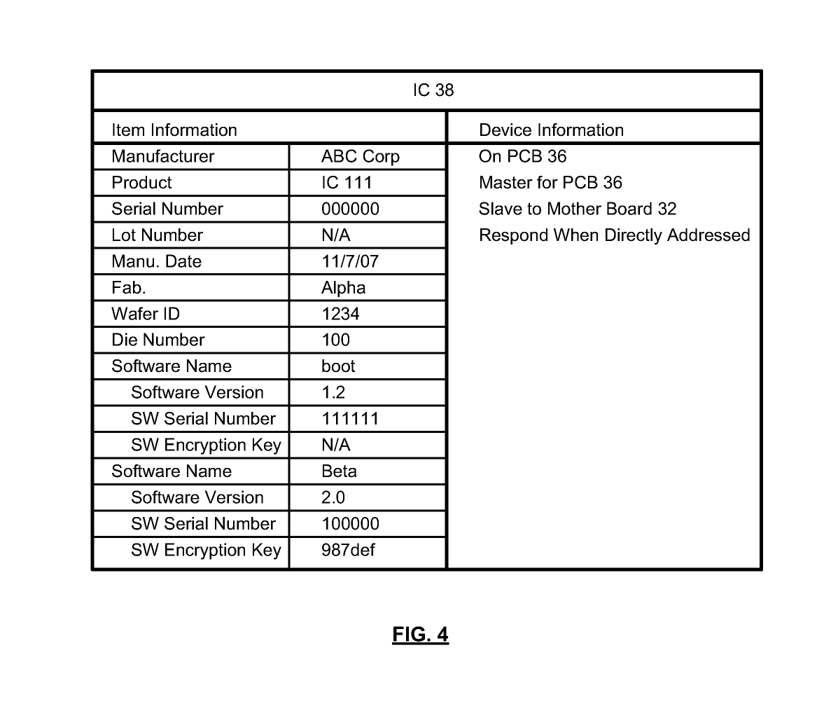

During the production of the device 10, the RFID tags 24 are used to relay assembly information regarding the production of the device 10 to an RFID reader. The assembly information may include item information (e.g., manufacturer, product type, serial number, etc.—further examples will be discussed with reference to FIGS. 3 and 4) regarding the parts of the device 10, test results of one or more production validation steps, and/or any other data desired regarding the production of the device 10. The RFID tags 24 may also be used to relay sub-assembly information regarding the production of a sub-assembly (e.g., the PCB 12) to the RFID reader. As such, the RFID tags 24 may be used during any phase of sub-assembly or final assembly of the device 10 or the part comprising the device 10.

The RFID reader, which may be included within the device 10 or may be a separate device, receives the assembly information from one or more of the RFID tags 24 during various stages of production of the device 10. The RFID reader may receive the assembly information in response to a request it transmitted, a request transmitted by production equipment, and/or based on a pre-programmed response of the RFID tag 24. Regardless of how the RFID reader receives the assembly information, it processes it to produce processed assembly information. For example, the RFID reader may receive assembly information from the RFID tags 24 associated with the PCB 12 and the parts thereon (e.g., ICs 18-20, component 14, memory 16). The RFID reader processes the assembly information to produce a detailed bill of material (e.g., part type, part number, manufacturer, dates, serial number, lot number, manufacturing site, test data, etc.), intermediate test data, and/or any other type of data regarding the assembly of the PCB 12 desired. The RFID reader may provide the processed assembly information to the assembly equipment.

As another example, the RFID reader may process the assembly information to categorize the device 10 and/or the parts comprising the device. For instance, if the assembly information includes test data regarding the speed of operation of speed dependent parts (e.g., processors, DSPs, memory, etc.), the RFID reader may categorize the device as a high speed device if all, or at least the critical ones, of its speed dependent parts are in the higher end of their respective speed ranges (e.g., a processor may have a clock rate of 2.00-2.66 GHz due, at least in part, to process variations). Further, the RFID reader may be used to assist in selecting parts to put into a device such that a high speed (moderate speed or low speed) device can be accurately produced, thereby enabling the manufacturer to charge a premium for the high speed devices and less for the moderate and low speed devices without final assembly testing of the speed of the device and/or parts of the device.

In addition to receiving assembly information from the RFID tags 24, the RFID reader may provide data to the RFID tags 24. For example, the RFID reader may provide association information to two or more RFID tags 24, wherein the association information indicates an interdependency between the parts associated with the RFID tags, response parameters, production step verification data, and/or any other data desired to be stored by an RFID tag regarding the production of the device 10. In addition, the association information may include a pointer to more information (e.g., to another RFID tag), a master slave relationship, and/or a listing of associations (e.g., layering of the associations).

For example, the RFID reader may establish, either independently or based on a command from the production equipment, an interdependency between the PCB 12, the component 14, the memory 16, and the ICs 18-20. The interdependency may be one layer (e.g., all of the parts of the PCB 12 are direct subordinates of the PCB 12), multiple layers (e.g., memory 16 is subordinate to ICs 18 and 20, which are subordinate to the PCB 12), or by functional grouping (e.g., parts related to a processing core are grouped separately from DSP functionality, etc.).

The RFID reader may establish response parameters based on the interdependency. For example, the response parameters may include: response only when directly addressed, a response ordering (e.g., a round robin manner, a token passing, a push-pull manner, etc.), function as a master for parts of the interdependency, function as a slave within the interdependency, etc. Further, the RFID reader may generate, directly or based on a command from the assembly equipment, production step verification data. For example, at a given production step of the device 10, a test may be performed (e.g., a continuity test, a timing test, etc.) and the results of that test may be downloaded to the appropriate RFID tag or tags by the reader. As the production of the device continues, similar information may be stored in the appropriate RFID tag or tags for the corresponding production step. Thus, if an error in production occurs, the stored production step verification data may be used to determine the precise nature of the error, when in the production the error occurred, and/or the conditions leading up to the error.

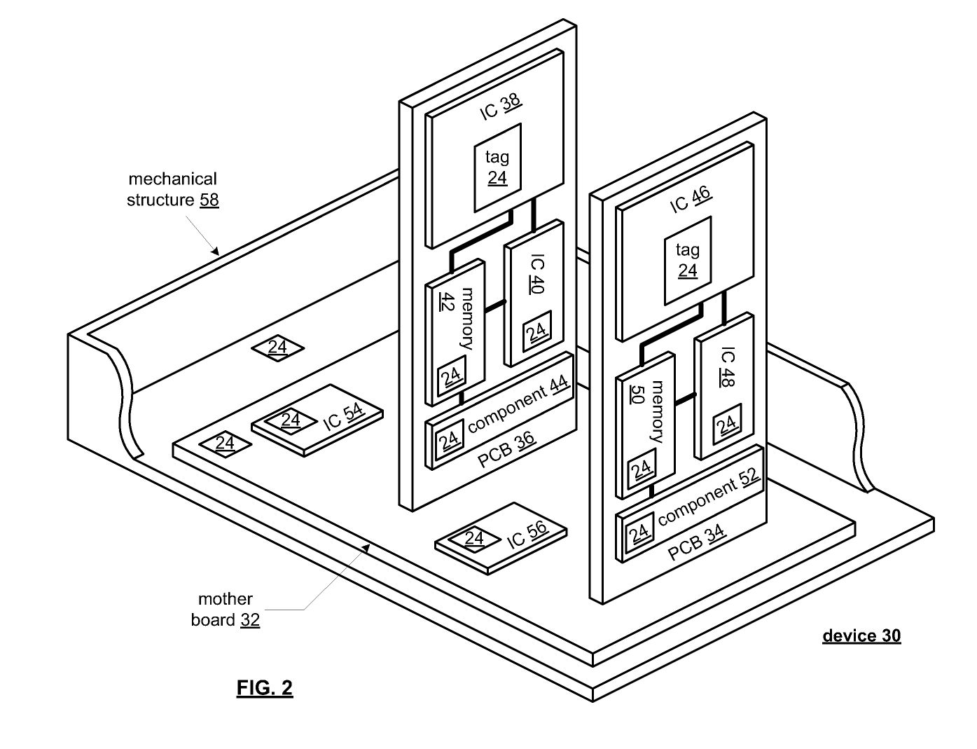

FIG. 2 is a diagram of another embodiment of a device 30 that includes a mother board 32, a plurality of PCBs 34-36, and a mechanical structure 58. The mother board 32 supports the plurality of PCBs 34-36, a plurality of ICs 54-56, an RFID tag 24, and may further support a plurality of components (not shown), memory devices, etc. Each of the PCBs 34-36 includes components 44, 52, memory devices 42, 50, and ICs 38-40 and 46-48. The device 30 may be a personal computer, a laptop computer, a persona digital assistant, an entertainment unit, a handheld video game unit, etc., and may include more components (e.g., resistors, capacitors, inductors, transformers, transistors, light emitting diodes, diodes, connectors, etc.), more ICs (e.g., processors, read only memory, random access memory, application specific ICs, digital signal processors, etc.), more PCBs, and/or more mechanical structures (e.g., chassis, brackets, heat sinks, hardware, etc.) than shown in FIG. 2.

In this embodiment each of the parts (e.g., 32-58) of the device 30 includes an associated radio frequency identification (RFID) tag 24. The RFID tags 24 may be active or passive tags integrated into their associated part (e.g., the ICs 38-40, 46-48, 54, 56 are fabricated to include an RFID tag within the IC) or affixed to their associated part (e.g., an integrated circuit version of an RFID tag is mounted on the PCB 32, 34, 36 or an IC version of the tag is glued to the mechanical structure 58). In an alternate embodiment, an RFID tag 24 may be affiliated with multiple parts or programmed to be affiliated parts. For example, the RFID tag 24 on the PCB 34 may be used to store item information for the PCB itself and for one or more parts mounted on the PCB (e.g., component 52).

During the production of the device 30, the RFID tags 24 are used to relay assembly information regarding the production of the device 30 to an RFID reader. The assembly information may include item information (e.g., manufacturer, product type, serial number, etc.—further examples will be discussed with reference to FIGS. 3 and 4) regarding the parts of the device 30, test results of one or more production validation steps, and/or any other data desired regarding the production of the device 30. The RFID tags 24 may also be used to relay sub-assembly information regarding the production of a sub-assembly (e.g., the PCB 34-36) to the RFID reader. As such, the RFID tags 24 may be used during any phase of sub-assembly or final assembly of the device 30 or the part comprising the device 30.

The RFID reader, which may be included within the device 30 or may be a separate device, receives the assembly information from one or more of the RFID tags 24 during various stages of production of the device 30. The RFID reader may receive the assembly information in response to a request it transmitted, a request transmitted by production equipment, and/or based on a pre-programmed response of the RFID tag 24. Regardless of how the RFID reader receives the assembly information, it processes it to produce processed assembly information and may provide the processed assembly information to the assembly equipment.

In addition to receiving assembly information from the RFID tags 24, the RFID reader may provide data to the RFID tags 24. For example, the RFID reader may provide association information to two or more RFID tags 24, wherein the association information indicates an interdependency between the parts associated with the RFID tags, response parameters, production step verification data, and/or any other data desired to be stored by an RFID tag regarding the production of the device 10. Further, the RFID reader may establish response parameters based on the interdependency. Still further, the RFID reader may generate, directly or based on a command from the assembly equipment, production step verification data.

FIG. 3 is a diagram of an example of a component's 44 assembly information that includes item information and device information. The item information includes information regarding the component, such as the manufacturer of the component, the product number, a serial number, a lot number, and/or a manufactured date. If the component includes software loaded thereon (e.g., a memory device storing a boot-up algorithm), the item information may further include the software name, the software version, a software serial number, an encryption key, and/or any other information regarding the software (SW). If the component includes an integrated circuit die, the item information may further include the name of the IC fabrication manufacturer, the wafer identification code, the die number, and/or any other information regarding the die.

The device information is generally information stored by the RFID tag 24 that it receives from the RFID reader. Thus, the device information may be association information, response parameters, production step verification data, and/or any other desired data. In this example, the device information includes the location of the component (e.g., on PCB 36), that it is a slave device with respect to the RFID tag on PCB 36, and it is to respond to the reader when directly addressed. Also, in this example, when a request is received by the RFID reader, the RFID tag of the PCB 36 will respond for the RFID tag of the component 44 unless the request is directly addressing the RFID tag of component 44.

FIG. 4 is a diagram of an example of an integrated circuit's 38 information that includes item information and device information. The item information includes information regarding the IC, such as the manufacturer of the IC, the product number, a serial number, a lot number, name of the IC fabrication manufacturer, the wafer identification code, the die number, and/or any other information regarding the die. In addition, the item information may include software vendor name, the name of the software, a software version, a software serial number, an encryption key, and/or any other information regarding the software (SW).

The device information may be association information, response parameters, production step verification data, and/or any other desired data. In this example, the device information includes the location of the IC (e.g., on PCB 36), that it is a master for the other ICs, components, memory devices on PCB 36, it is a slave to mother board 32, and it is to respond to the reader when directly addressed. For instance, when a request is received by the RFID reader, the RFID tag of IC 38 will respond for the RFID tags of the parts on PCB 36 if the request is for the RFID tag of IC 38, the PCB 36, and/or for one of the parts on PCB 36. If the request is not addressing the RFID tag of IC 38 and/or the parts of PCB 36, the RFID tag of 38 will not respond; it will let the RFID tag of the mother board respond.

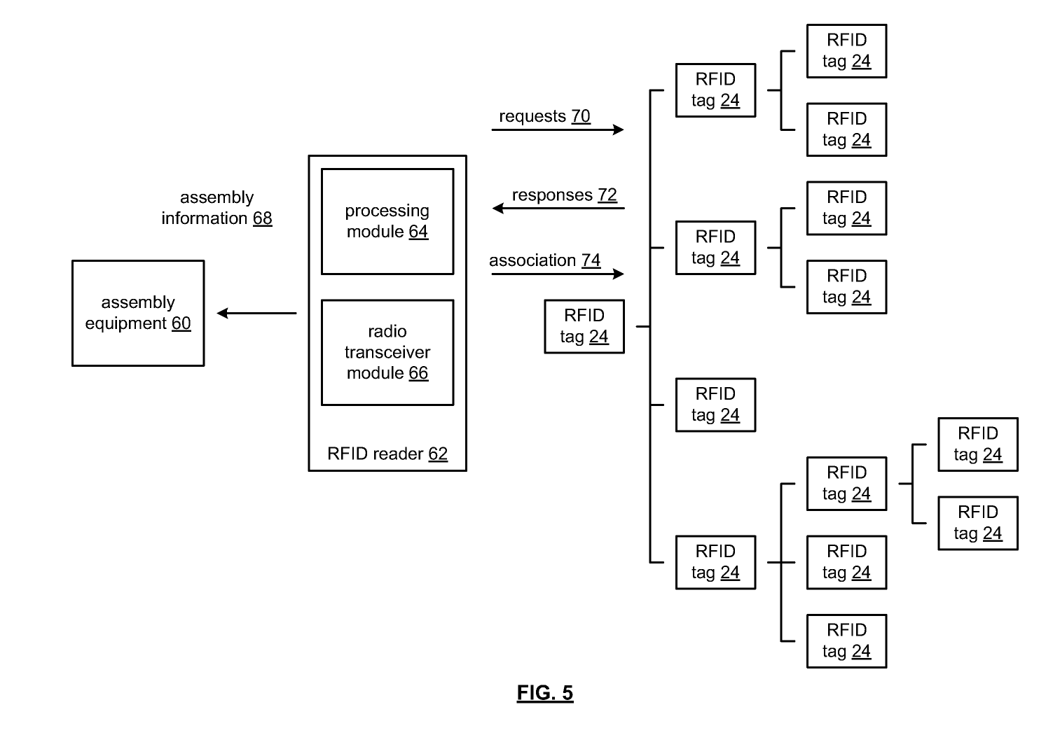

FIG. 5 is a diagram of an example of an RFID communication between a plurality of RFID tags 24, an RFID reader 62, and assembly equipment 60. Each of the RFID tags 24 may include a power generating circuit, a current reference, an oscillation module, a processing module, an oscillation calibration module, a comparator, an envelope detection module, a resistor, a capacitor, and a transistor. The current reference, the oscillation module, the processing module, the oscillation calibration module, the comparator, and the envelope detection module may be a single processing device or a plurality of processing devices. In operation, the power generating circuit generates a supply voltage (V_{DD}) from a radio frequency (RF) signal that is received via an antenna and, if included, resistor R1. The power generating circuit stores the supply voltage V_{DD} in capacitor C1 and provides it to the other modules of the RFID tag.

When the supply voltage V_{DD} is present, the envelope detection module determines an envelope of the RF signal, which includes a DC component corresponding to the supply voltage V_{DD}. The envelope detection module provides an envelope signal to the comparator, which compares the envelope signal with a threshold to produce a stream of recovered data.

The oscillation module, which may be a ring oscillator, crystal oscillator, or timing circuit, generates one or more clock signals that have a rate corresponding to the rate of the RF signal in accordance with an oscillation feedback signal. For instance, if the RF signal is a 900 MHz signal, the rate of the clock signals will be n*900 MHz, where “n” is equal to or greater than 1. The oscillation calibration module produces the oscillation feedback signal from a clock signal of the one or more clock signals and the stream of recovered data. In general, the oscillation calibration module compares the rate of the clock signal with the rate of the stream of recovered data. Based on this comparison, the oscillation calibration module generates the oscillation feedback to indicate to the oscillation module to maintain the current rate, speed up the current rate, or slow down the current rate.

The processing module receives the stream of recovered data and a clock signal of the one or more clock signals. The processing module interprets the stream of recovered data to determine a command or commands contained therein (e.g., association information). If the command(s) requires a response, the processing module provides a signal to the transistor at a rate corresponding to the RF signal. The signal toggles transistor on and off to generate an RF response signal that is transmitted via the antenna.

The RFID reader 62 includes a processing module 64 and a radio transceiver 66. The processing module 64 may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module may have an associated memory and/or memory element, which may be a single memory device, a plurality of memory devices, and/or embedded circuitry of the processing module. Such a memory device may be a read-only memory, random access memory, volatile memory, non-volatile memory, static memory, dynamic memory, flash memory, cache memory, and/or any device that stores digital information. Note that when the processing module implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Further note that, the memory element stores, and the processing module executes, hard coded and/or operational instructions corresponding to at least some of the steps and/or functions illustrated in FIGS. 1-7.

For a given production step of a device 10 or 30, the processing module 64 of the RFID reader 62 convert a first assembly information request into a first outbound symbol stream in accordance with an RFID protocol. For instance, the RFID protocol may be a near field communication protocol or a far field communication protocol. For example, the International Organization for Standardization (ISO) has developed an RFID standard called the ISO 18000 series. The ISO 18000 series standard describes air interface protocols for RFID systems especially in applications used to track items in a supply chain. The ISO 18000 series has seven parts to cover the major frequencies used in RFID systems around the world. The seven parts are:
18000-1: Generic parameters for air interfaces for globally accepted frequencies;
18000-2: Air interface for below 135 KHz;
18000-3: Air interface for 13.56 MHz;
18000-4: Air interface for 2.45 GHz;
18000-5: Air interface for 5.8 GHz;
18000-6: Air interface for 860 MHz to 930 MHz;
18000-7: Air interface at 433.92 MHz.

According to the ISO 18000-2 and 18000-3 parts of the ISO 18000 series, near-field technology with magnetic/inductive coupling has an air interface protocol at low frequency (LF) of 135 KHz or less or at 13.56 high frequency (HF). ISO 18000-3 defines two modes. In mode 1, the tag to reader data rate is 26.48 kbps while mode 2 is a high speed interface of 105.9375 kbps on each of 8 channels. The communication protocol used by the reader and the tag is typically a load modulation technique.

Far field technology with RF backscatter coupling has three ISO defined air interfaces at 2.45 GHz microwave frequency according to ISO 18000-5, 860 MHZ to 930 MHz ultra high frequency (UHF) range according to ISO 18000-6 and 433.92 MHz UHF according to ISO 18000-7. For UHF at 860-930 MHz, the ISO 18000-6 has defined two tag types, Type A and Type B with a tag to reader link defined as including 40 kbps data rate, Amplitude Shift Keying (ASK) modulation, and biphase-space or FM0 encoding of data. In addition, the EPC global Class 1, Generation 2 standard defines a tag standard using UHF with a tag to reader link of 40 to 640 kbps, ASK or Phase Shift Keying (PSK) modulation and data encoding of FM0 or Miller-modulated subcarrier.

The radio transceiver section 66 converts convert the first outbound symbol stream into a first outbound RF signal in accordance with the RFID protocol. The first outbound RF signal includes one or more requests 70 addressing one or more of the RFID tags 24. The RFID tags 24 receive the request 70, determine whether it is being addressed, determine a response ordering, determine master-slave relationship, and/or whether the request includes a command for storing association information or other type of information.

In this example, the tags are arranged in a hierarchical manner. The hierarchical manner may be based on the associations 74 established by the RFID reader and may be used to establish the response ordering. For example, if an RFID tag 24 receives a request 70 and it is not specifically addressed in the request, the RFID tag 24 determines whether it is a master or a slave with respect to the request. If the tag is a slave for this particular request, it does not directly respond to the RFID reader, it relies on the master to provide the appropriate response. Note that the slave RFID tag may communicate with the master RFID tag to provide its information for the response 72 prior to the master RFID tag responding.

When more than one RFID tag 24 is responding to a request, the response ordering provides an order in which the RFID tags are to respond to reduce collisions. For example, the RFID reader may establish the response ordering in a time division multiple access (TDMA) manner by including an individual time delay for each of the RFID tags within the request. As another example, the RFID reader may poll the RFID tags for their responses 72.

The radio transmitter section 66 receives a response 72 as a first inbound radio frequency (RF) signal. The radio transmitter section 66 converts the first inbound RF signal into a first inbound symbol stream in accordance with the RFID protocol. The processing module 64 converts the first inbound symbol stream into a first response.

At another production step of a device 10 or 30, the processing module 64 converts a second assembly information request into a second outbound symbol stream in accordance with the RFID protocol. The radio transmitter section 66 convert the second outbound symbol stream into a second outbound RF signal, which is transmitted as a request 70 to the RFID tags 24.

One more of the RFID tags 24 generates a response 72 in accordance with the request 70, which is received by the radio transceiver section 66 as a second inbound RF signal. The radio transceiver section 66 converts the second inbound RF signal into the second inbound symbol stream. The processing module 64 converts the second inbound symbol stream into a second response in accordance with the RFID protocol.

As processing module 64 collects the responses 72, it may process them individually or in a group to produce processed assembly information 68. The processing module 64 may convey the processed assembly information to assembly equipment 60 when requested by the assembly equipment 60 or as programmed. The assembly equipment 60 may be a computer to facilitate the production and/or testing of the device, automated production equipment, and/or any other piece of production equipment.

The processing module 64 may processing the responses 72 by interpreting the responses 72 to obtain item information regarding the parts associated with the responding RFID tags. The processing module 64 may then compile the item information regarding the parts to produce the processed assembly information 68.

In addition to, or in the alternative of, the processing module 64 may process the responses 72 by interpreting them to determine at least one association between two or more of the tags and their associated parts. The processing module 64 then converts the association 74 into a third outbound symbol stream, wherein the outbound symbol stream includes a command to store the association. The radio transceiver section 66 converts the third outbound symbol stream into a third outbound RF signal that is transmitted to one or more of the RFID tags.

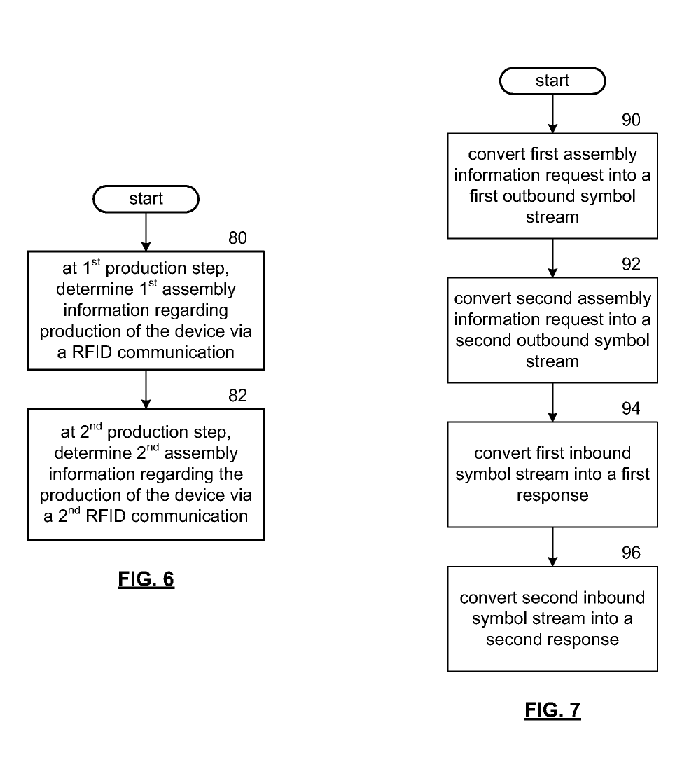

FIG. 6 is a logic diagram of an example of an RFID communication that begins at step 80 where, at a first production step of a device, an RFID reader determines first assembly information regarding production of the device via a first radio frequency identification (RFID) communication. The method continues at step 82 where, at a second production step, the RFID reader determines second assembly information regarding the production of the device via a second RFID communication.

In an embodiment, the first or second RFID communication may be achieved by the RFID reader transmitting an assembly information request. In this embodiment, an RFID tag transmits a response to the request. The RFID tag may be associated with any of the parts of the device.

In another embodiment, the first or second RFID communication may be achieved by the RFID reader transmitting an assembly information request. In this embodiment, two or more of the RFID tags transmit a corresponding response. The RFID reader the processes the corresponding response from each of the at least one of the plurality of RFID tags to produce processed assembly information. The RFID reader conveys the processed assembly information to assembly equipment.

The processing module may process the corresponding responses by interpreting the corresponding response to obtain item information regarding the part associated with the RFID tag. The processing module may then compile the item information to produce the processed assembly information.

In another embodiment, the first or second RFID communication may be achieved by the RFID reader transmitting an assembly information request. In this embodiment, a a master one of the plurality of RFID tags transmits the corresponding responses for at least some of the plurality of RFID tags.

FIG. 7 is a logic diagram of an example of an RFID reader processing an RFID communication that begins at step 90 where a processing module converts a first assembly information request into a first outbound symbol stream in accordance with an RFID protocol. The method continues at step 92 where the processing module converts a second assembly information request into a second outbound symbol stream in accordance with the RFID protocol, wherein the first and second assembly information request are concerning assembly of a device. The method continues at step 94 where the processing module converts a first inbound symbol stream into a first response, wherein the first response corresponds to the first assembly information request. The method continues at step 96 where the processing module converts a second inbound symbol stream into a second response, wherein the second response corresponds to the second assembly information request.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “coupled to” and/or “coupling” and/or includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” indicates that an item includes one or more of power connections, input(s), output(s), etc., to perform one or more its corresponding functions and may further include inferred coupling to one or more other items. As may still further be used herein, the term “associated with”, includes direct and/or indirect coupling of separate items and/or one item being embedded within another item. As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

What is claimed is:

1. A method comprises:
at a first production step of a device, determining first assembly information regarding production of the device via a first radio frequency identification (RFID) communication; and
at a second production step, determining second assembly information regarding the production of the device via a second RFID communication.

2. The method of claim 1, wherein at least one of the first and second RFID communications comprises:
transmitting, by an RFID reader, an assembly information request; and
transmitting, by an RFID tag, a response, wherein the RFID tag is associated with at least one of: a component, an integrated circuit (IC), a printed circuit board (PCB), and a mechanical structure and wherein the response includes assembly information regarding the at least one of: the component, the IC, the PCB, and the mechanical structure.

3. The method of claim 1, wherein at least one of the first and second RFID communications comprises:
transmitting, by an RFID reader, an assembly information request; and
transmitting, by at least one of a plurality of RFID tags, a corresponding response, wherein an RFID tag of the plurality of RFID tags is associated with a corresponding one of a plurality of integrated circuits, a corresponding one of a plurality of printed circuit boards, a corresponding one of a plurality of components, a corresponding one of a plurality of sub-assemblies, or a corresponding one of a plurality of mechanical structures.

4. The method of claim 3, wherein at least one of the first and second RFID communications comprises:
processing, by the RFID reader, the corresponding response from each of the at least one of the plurality of RFID tags to produce processed assembly information; and
conveying, by the RFID reader, the processed assembly information to assembly equipment.

5. The method of claim 4, wherein the processing the corresponding response comprises:
interpreting the corresponding response to obtain item information regarding the corresponding one of the plurality of integrated circuits, the corresponding one of the plurality of printed circuit boards, the corresponding one of the plurality of components, the corresponding one of the plurality of sub-assemblies, or the corresponding one of the plurality of mechanical structures associated with the at least one of the plurality of RFID tags; and
compiling the item information regarding a plurality of the corresponding ones of the plurality of integrated circuits, of the plurality of printed circuit boards, of the plurality of components, of the plurality of sub-assemblies, or of the plurality of mechanical structures to produce the processed assembly information.

6. The method of claim 5 further comprises:
interpreting the item information to determine at least one association between a first one of the plurality of RFID tags and a second one of the RFID tags;
transmitting, by the RFID reader, the association to the first one and second one of the RFID tags; and
storing, by the first and second ones of the RFID tags, the association.

7. The method of claim 6 further comprises:
at the second production step or another production step, transmitting, by the RFID reader, the second or another assembly information request;
receiving, by the first and second ones of the RFID tags, the second or the another assembly information request;
generating, by at least one of the first and second ones of the RFID tags, a response to the second or the another information request in accordance with the association; and
transmitting, by the at least one of the first and second ones of the RFID tags, the response to the RFID reader in accordance with the association.

8. The method of claim 5, wherein the item information comprises at least one of:
manufacturer, product type, serial number, manufacturing lot, date, fabrication facility, wafer number, die number, software name, software version, software serial number, and software encryption key.

9. The method of claim 1, wherein at least one of the first and second RFID communications comprises:
transmitting, by an RFID reader, an assembly information request; and
transmitting, by a master one of the plurality of RFID tags, the corresponding responses for at least some of the plurality of RFID tags, wherein an RFID tag of the plurality of RFID tags is associated with a corresponding one of a plurality of integrated circuits, a corresponding one of a plurality of printed circuit boards, a corresponding one of a plurality of components, a corresponding one of a plurality of sub-assemblies, or a corresponding one of a plurality of mechanical structures.

10. A radio frequency identification (RFID) reader comprises:
a processing module coupled to:
convert a first assembly information request into a first outbound symbol stream in accordance with an RFID protocol;
convert a second assembly information request into a second outbound symbol stream in accordance with the RFID protocol, wherein the first and second assembly information request are concerning assembly of a device;
convert a first inbound symbol stream into a first response, wherein the first response corresponds to the first assembly information request; and
convert a second inbound symbol stream into a second response, wherein the second response corresponds to the second assembly information request;
a radio transceiver section coupled to:
convert a first inbound radio frequency (RF) signal into the first inbound symbol stream, wherein at least one of a plurality of RFID tags transmitted the first inbound RF signal in response to the first assembly information request, wherein the at least one of the RFID tags is associated with at least one of: a component, an integrated circuit (IC), a printed circuit board (PCB), and a mechanical structure and wherein the response includes assembly information regarding the ate least one of: the component, the IC, the PCB, and the mechanical structure;
convert a second inbound RF signal into the second inbound symbol stream, wherein the at least one or another one of a plurality of RFID tags transmitted the second inbound RF signal in response to the second assembly information request;
convert the first outbound symbol stream into a first outbound RF signal; and
convert the second outbound symbol stream into a second outbound RF signal.

11. The RFID reader of claim 10, wherein the processing module is further coupled to:
process the first and second responses to produce processed assembly information; and
convey the processed assembly information to assembly equipment.

12. The RFID reader of claim 11, wherein the processing module is further coupled to:
interpret the first and second responses to obtain item information regarding the corresponding one of the plurality of integrated circuits, the corresponding one of the plurality of printed circuit boards, the corresponding one of the plurality of components, the corresponding one of the plurality of sub-assemblies, or the corresponding one of the plurality of mechanical structures associated with the at least one or the another one of the plurality of RFID tags; and
compile the item information regarding a plurality of the corresponding ones of the plurality of integrated circuits, of the plurality of printed circuit boards, of the plurality of components, of the plurality of sub-assemblies, or of the plurality of mechanical structures to produce the processed assembly information.

13. The RFID reader of claim 11, wherein the processing module is further coupled to:
interpreting the item information to determine at least one association between the at least one of the plurality of RFID tags and the another one of the plurality of RFID tags; and
convert the association into a third outbound symbol stream, wherein the third outbound symbol stream includes a command to store the association.

14. The RFID reader of claim 11, wherein the item information comprises at least one of:
manufacturer, product type, serial number, manufacturing lot, date, fabrication facility, wafer number, die number, software name, software version, software serial number, and software encryption key.

15. A device comprises:
a first integrated circuit (IC) having a first radio frequency identification (RFID) tag;
a second IC having a second RFID tag;
a printed circuit board (PCB) that supports at least one of the first and second ICs, wherein the PCB includes a third RFID tag;
a component having a fourth RFID tag, wherein, at a first production step of the device, at least one of the first through fourth RFID tags provide a first assembly response regarding production of the device via a first RFID communication and, at a second production step, at least one of the first through fourth RFID tags provide a second assembly response regarding the production of the device via a second RFID communication.

16. The device of claim 15, wherein at least one of the first and second RFID communications comprises:
transmitting, by an RFID reader, an assembly information request; and
transmitting, by the at least one of the first through fourth RFID tags, the first or second assembly response.

17. The device of claim 16 further comprises:
the RFID reader to support at least one of the first and second RFID communications by:
processing the corresponding response from each of the at least one of the plurality of RFID tags to produce processed assembly information; and
conveying the processed assembly information to assembly equipment.

18. The device of claim 16, wherein the RFID reader further functions to process the corresponding response by:
interpreting the corresponding response to obtain item information regarding the corresponding one of the first and second ICs, the PCB, and the component; and
compiling the item information regarding the first and second ICs, the PCB, and the component to produce the processed assembly information.

19. The device of claim 18, wherein the RFID reader further functions to:
interpret the item information to determine at least one association between at least two of the first through fourth RFID tags; and
transmit the association to the at least two of the first through fourth RFID tags, wherein the at least two of the first through fourth RFID tags store the association.

20. The device of claim 19 further comprises:
the RFID reader transmitting the second or another assembly information request at the second production step or another production step;
the at least two of the first through fourth RFID tags receive the second or the another assembly information request;
at least one of the at least two of the first through fourth RFID tags generate a response to the second or the another information request in accordance with the association; and
the at least one of the at least two of the first through fourth RFID tags transmits the response to the RFID reader in accordance with the association.

21. The device of claim 18, wherein the item information comprises at least one of:
manufacturer, product type, serial number, manufacturing lot, date, fabrication facility, wafer number, die number, software name, software version, software serial number, and software encryption key.

22. The device of claim 15 further comprises:
one of the first through fourth RFID tags being designated as a master RFID tag and the other RFID tags of the first through fourth RFID tags being designated as slave RFID tags.
